(19) United States
(12) Patent Application Publication
(10) Pub. No.: US 2005/0282093 A1
(43) Pub. Date: Dec. 22, 2005

(54) Aqueous edge bead remover

(76) Inventors: Ralph R. Dammel, Flemington, NJ (US); Stephen Meyer, Tobyhanna, PA (US); Mark A. Spak, Edison, NJ (US)

Correspondence Address: Alan P. Kass;Clariant Corporation, 70 Meister Avenue, Somerville, NJ, 08876, US

(21) Appl. No.: 10/869,417

(22) Filed: Jun. 16, 2004

(51) Int. Cl. G03C 5/00

(52) U.S. Cl. 430/331

(57) ABSTRACT

The present invention relates to an aqueous based edge bead remover.

### BACKGROUND OF THE INVENTION

The present invention relates generally to the field of microelectronics, e.g., integrated circuits, and more particularly to compositions and methods for removing photoresist compositions from the surfaces of substrates, e.g., silicon wafers, used in the fabrication of integrated circuits. In its most particular regard, the invention relates to compositions and methods for removing unwanted edge residues of photoresist composition from a wafer which has been spin-coated with photoresist.

In very general terms, the fabrication of integrated circuits involves steps for producing polished silicon wafer substrates, steps for imaging integrated circuit pattern geometries on the various wafer surfaces, and steps for generating the desired pattern on the wafer.

The imaging process involves the use of photoresists applied to the wafer surface. Photoresists are compositions which undergo change in response to light of particular wavelength such that selective exposure of the composition through a suitable patterned mask, followed by development to remove exposed or non-exposed portions of the photoresist as the case may be, leaves on the wafer a pattern of resist which replicates either the positive or negative of the mask pattern, and which thus permits subsequent processing steps (e.g., deposition and growth processes for applying various layers of semiconductive materials to the wafer and etching-masking processes for removal or addition of the deposited or grown layers) to be carried out in the desired selective pattern.

The photoresists used in the imaging process are liquid compositions of organic light-sensitive materials which are either polymers per se or are used along with polymers, dissolved in an organic solvent. Critical to the effectiveness of the selective light exposure and development in forming a resist pattern on the wafer substrate is the initial application of the photoresist composition in a thin layer of essentially uniform thickness on the wafer surface. Coating processes used in the industry include spin-coating, spray coating, dip coating or roller coating. Spin-coating is the preferred process in the industry.

Despite its widespread use, certain undesirable results also accompany spin-coating. Thus, owing to the surface tension of the resist composition, some of the resist may wick around to and coat the back side edge of the wafer during the spin-coating process. Also, as the spin-coating process progresses, the resist becomes progressively more viscous as solvent evaporates therefrom and resist being spun off the wafer in the latter stages of the process can leave fine whiskers (“stringers”) of resist which dry on the edge of the wafer. So too, as the resist continues to dry and increase in viscosity during the spin-coating process, excess resist is less likely to leave the wafer and instead builds up as an edge-bead at the outer reaches of the wafer surface.

These coating-related problems can cause significant difficulties in the overall integrated circuit fabrication process. Resist on the back side of the wafer can be deposited elsewhere and cause contamination, and also prevents the wafer from lying flat on ultraflat surfaces, thereby affecting focus, alignment, planarity, and the like, in subsequent imaging steps. Whiskers on the wafer edges can easily break off in subsequent processing steps and cause particulate contamination in virtually all of the manufacturing equipment. Finally, the edge-bead leads to a distorted surface which can greatly affect focus, alignment, planarity and the like. Edge bead results from certain characteristics of the photoresist coating process. That is, the photoresist is coated onto a wafer by dispensing the photoresist material onto a surface of the wafer while the wafer is rotating. As a result, the photoresist material tends to accumulate at the edge of the wafer, forming a so-called edge bead. Also, during the spraying process, photoresist material inevitably becomes coated onto the backside of the wafer. Accordingly, in the edge bead remover process, a stripper composition is used to remove any unwanted photoresist from the edge and backside of the wafer.

The art is aware of the problems associated with residual resist at the edges and sides of the wafer, and generally seeks to overcome them by application at the edge of the wafer of a small stream of a solvent for the resist so as to dissolve and remove the unwanted residue. In many cases, the solvent stream is applied to the backside edge of the wafer and is permitted to wick around by capillary action to the front edges so as to remove backside edge residue, whiskers and edge bead. With certain newer equipment, it is possible to apply the solvent stream from both front and back sides of the wafer simultaneously. In all cases, the object essentially is to remove from the wafer a strip of resist which is adhered to the wafer sides, the back surface outer edges of the wafer, and the outer edges of the front surface of the wafer, to leave as defect-free a film as possible.

Solvent compositions are known which may be used for removing undesired edge bead from spun photoresist wafers and cleaning related photoresist processing equipment. However, such compositions are generally extremely toxic, ecologically undesirable and/or are unpleasantly odorous as well as causing swelling of the photoresist film in the area of application of the solvent based edge bead compositions.

U.S. Pat. No. 6,503,694 discusses an edge bead remover system containing water, a basic compound and a surfactant having the formula

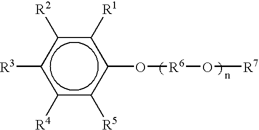

R¹, R², R³, R⁴ and R⁵ are selected from the group consisting of hydrogen, alkyl, aryl, aralkyl and halogen, and at least two of R¹, R², R³, R⁴ and R⁵ are aralkyl or aryl,

R⁶ is selected from the group consisting of ethylene, propylene, and butylene,

R⁷ is selected from the group consisting of hydrogen, acetyl, alkyl, and aryl, and

n is an integer ranging from 6 to 23.

The surfactants in U.S. Pat. No. 6,503,694 generally fall within the class of surfactants known as nonylphenoxy ethoxylates which are known to present environmental and health issues.

### SUMMARY OF THE INVENTION

The invention provides an edge bead remover composition comprising, or more particularly consisting essentially of, from about 0.5 to about 8 Normal solution of a basic compound. The basic compound can be selected from ammonium hydroxides, organic amines, alkali metal compounds, alkaline earth metal compounds, and mixtures thereof. The composition can further comprise a non-ionic surfactant. Embodiments include non-ionic surfactants selected from the group consisting of (i) HO(EO)ₐ(PO)_{b}(EO)ₐH, where EO is ethylene oxide, PO is propylene oxide (either CH—(CH₃)—CH₂—O or CH₂—CH(CH₃)—O), a is a number between about 1 to about 140 and b is a number between about 5 to about 100; (ii) HO(PO)_{b}(EO)ₐ(PO)_{b}H where EO, PO, a and b are as defined in (i); (iii) R—[O-(AO)ₙ]ₘ—H, where AO is an alkylene oxide unit selected from EO and PO; n is at least about 5, m is from 1 to 3; and (iv) mixtures thereof.

In addition, the present invention also provides a process for removing photoresist edge bead and forming an image in the photoresist comprising the steps of a) forming a photoresist film on a substrate; b) applying an edge bead remover composition comprising, or more particularly consisting essentially of, from about 0.5 to about 8 Normal solution of a basic compound; c) imagewise exposing the photoresist film; d) developing the photoresist film; and e) optionally heating the film before or after the developing step. The edge bead remover composition can further comprise a non-ionic surfactant. The non-ionic surfactant can be selected from the group consisting of (i) HO(EO)ₐ(PO)_{b}(EO)ₐH, where EO is ethylene oxide, PO is propylene oxide, a is a number between about 1 to about 140 and b is a number between about 5 to about 100; (ii) HO(PO)_{b}(EO)ₐ(PO)_{b}H where EO, PO, a and b are as defined in (i); (iii) R—[O-(AO)ₙ]ₘ—H, where AO is an alkylene oxide unit selected from EO and PO; n is at least about 5, m is from 1 to 3; and (iv) mixtures thereof.

It has been found that the use of a solvent-free, basic compound based edge bead remover provided a sharply defined edge formed by the dissolution of the resist film, especially for thick film (greater than 20 μm) photoresists and, on an environmental note, reduces volatile organic emissions. When solvent based edge bead removers are used with resist films, swelling of the film in the zone adjacent to the new edge bead formed is observed Swelling of the film can lead to deleterious effects within the film. The use of solvent-based edge bead removers raises safety issues as well as volatile organic emissions.

### DETAILED DESCRIPTION OF THE INVENTION

The invention provides an edge bead remover composition comprising, or more particularly consisting essentially of, from about 0.5 to about 8 Normal solution of a basic compound. The basic compound can be selected from ammonium hydroxides, organic amines, alkali metal compounds, alkaline earth metal compounds, and mixtures thereof. The composition can further comprise a non-ionic surfactant. Embodiments include non-ionic surfactants selected from the group consisting of (i) HO(EO)ₐ(PO)_{b}(EO)ₐH, where EO is ethylene oxide, PO is propylene oxide (either CH—(CH₃)—CH₂—O or CH₂—CH(CH₃)—O), a is a number between about 1 to about 140 and b is a number between about 5 to about 100; (ii) HO(PO)_{b}(EO)ₐ(PO)_{b}H where EO, PO, a and b are as defined in (i); (iii) R—[O-(AO)ₙ]ₘ—H, where AO is an alkylene oxide unit selected from EO and PO; n is at least about 5, m is from 1 to 3; and (iv) mixtures thereof.

In addition, the present invention also provides a process for removing photoresist edge bead and forming an image in the photoresist comprising the steps of a) forming a photoresist film on a substrate; b) applying an edge bead remover composition comprising, or more particularly consisting essentially of, from about 0.5 to about 8 Normal solution of a basic compound; c) imagewise exposing the photoresist film; d) developing the photoresist film; and e) optionally heating the film before or after the developing step. The edge bead remover composition can further comprise a non-ionic surfactant. The non-ionic surfactant can be selected from the group consisting of (i) HO(EO)ₐ(PO)_{b}(EO)ₐH, where EO is ethylene oxide, PO is propylene oxide, a is a number between about 1 to about 140 and b is a number between about 5 to about 100; (ii) HO(PO)_{b}(EO)ₐ(PO)_{b}H where EO, PO, a and b are as defined in (i); (iii) R—[O-(AO)ₙ]ₘ—H, where AO is an alkylene oxide unit selected from EO and PO; n is at least about 5, m is from 1 to 3; and (iv) mixtures thereof.

The edge bead remover is typically from about 0.5 to about 8 Normal solution of a basic compound. The basic compound (B) may be an organic basic compound or an inorganic basic compound. The organic basic compound is selected from the group consisting of ammonium hydroxides and organic amines. Examples of the ammonium hydroxides include tetramethyl ammonium hydroxide and 2-hydroxy trimethyl ammonium hydroxide. Examples of the organic amines include monomethylamine, dimethylamine, trimethylamine, diethylamine, triethylamine, monoiso-pyruamine, di-isopyruamine, ethanolamine, and mixtures thereof.

The inorganic basic compound may be an alkali metal compound or an alkaline earth metal compound, and is selected from the group consisting of lithium hydroxide, sodium hydroxide, potassium hydroxide, sodium hydrogen-phosphate, ammonium dihydrogen-phosphate, sodium dihydrogen-phosphate, potassium dihydrogen-phosphate, lithium phosphate, lithium silicate, potassium silicate, sodium silicate, lithium carbonate, potassium carbonate, sodium carbonate, lithium borate, sodium borate, and mixtures thereof.

The basic compound is typically present in an amount so as to form from about 0.5 to about 8 Normal solution of the basic compound, more preferably from about 3 Normal to about 6 Normal solution.

The non-ionic surfactants that can be used are well known to those skilled in the art. Examples of non-ionic surfactants include those such as, for example, polyoxyethylene alkyl ether having the general formula R—[O-(AO)ₙ]ₘ—H, where AO is an alkylene oxide unit selected from EO and Patent Office, R is a hydrophobic group, e.g., C₈₋₂₀ straight or branched alkyl group, and the like, n is at least about 5, m is from 1 to 3, e.g., polyoxyethylene lauryl ether, polyoxyethylene stearyl ether, polyoxyethylene cetyl ether or polyoxyethylene oleyl ether; a polyoxyethylene/polyoxypropylene block copolymer; a sorbitan fatty acid ester, e.g., sorbitan monolaurate, sorbitan monopalmitate, sorbitan monostearate, sorbitan monooleate, sorbitan trioleate or sorbitan tristearate; or a polyoxyethylene sorbitan fatty acid ester, e.g., polyoxyethylene sorbitan monolaurate, polyoxyethylene sorbitan monopalmitate, polyoxyethylene sorbitan monostearate, polyoxyethylene sorbitan trioleate or polyoxyethylene sorbitan tristearate; ethylene oxide/propylene oxide/ethylene oxide block polymer (e.g., HO(EO)ₐ(PO)_{b}(EO)ₐH, where EO is ethylene oxide, PO is propylene oxide, a is a number between about 1 to about 140 and b is a number between about 5 to about 100); propylene oxide/ethylene oxide/ propylene oxide block polymer (e.g., HO(PO)_{b}(EO)ₐ(PO)_{b}H where EO, PO, a and b are as defined above), and mixtures thereof. Examples of the non-ionic surfactants are available under various tradenames such as Emulgen, Pluronic, Emkalyx, Lutrol, Supronic, Monolan, Pluracare, and Plurodac, as well as others known to those skilled in the art.

A commercially available edge bead remover (70/30 w/w 1-Methoxy-2-propanol/Methoxy-2-propanol acetate) was evaluated against a 3N NaOH solution. Wafers were coated with AZ P4903 photoresist (available from Clariant Corporation, AZ Electronic Materials, Somerville, N.J.) and baked on a hotplate, forming 65 μm films. Either droplets of the commercially available edge bead remover or 3N NaOH were applied in static mode to the wafers and were allowed to remain on the film for about 2 minutes. After about 2 minutes, the droplets were washed off with deionized water and the wafers were spun dry.

In the case of the commercial edge bead remover, swelling of film was observed in the zone adjacent to the new edge being formed. In the case of 3N NaOH, a sharply defined edge was formed by dissolution of the film without swelling, a desirable effect.

While described in terms of the embodiments presented herein, it is to be understood that the present disclosure is to be interpreted as by way of illustration, and not by way of limitation, and that various modifications and alterations apparent to one skilled in the art may be made without departing from the scope and spirit of the present invention.

1. An edge bead remover composition for a photoresist composition disposed as a film on a surface consisting essentially of from about 0.5 to about 8 Normal solution of a basic compound.

2. The composition according to claim 1 wherein the basic compound is selected from the group consisting of ammonium hydroxides, organic amines, alkali metal compounds, alkaline earth metal compounds, and mixtures thereof.

3. The composition according to claim 1 wherein the basic compound is an ammonium hydroxide selected from the group consisting of tetramethylammonium hydroxide, tetraethylammonium hydroxide, tetrapropylammonium hydroxyl, tetrabutylammonium hydroxide, 2-hydroxy-trimethylammonium hydroxide, and mixtures thereof.

4. The composition according to claim 1 wherein the basic compound is an organic amine selected from the group consisting of monomethylamine, dimethylamine, trimethylamine, diethylamine, triethylamine, monoiso-pyruamine, di-isopyruamine, ethanolamine, and mixtures thereof.

5. The composition according to claim 1 wherein the basic compound is an alkali metal compound or a basic earth metal compound selected from the group consisting of lithium hydroxide, sodium hydroxide, potassium hydroxide, sodium hydrogen-phosphate, ammonium dihydrogen-phosphate, sodium dihydrogen-phosphate, potassium dihydrogen-phosphate, lithium phosphate, lithium silicate, potassium silicate, sodium silicate, lithium carbonate, potassium carbonate, sodium carbonate, lithium borate, sodium borate, and mixtures thereof.

6. The composition according to claim 1 which further comprises from about 0.1 to about 10 wt % of a non-ionic surfactant.

7. The composition according to claim 6 wherein the non-ionic surfactant is selected from the group consisting of polyoxyethylene alkyl ether, polyoxyethylene/polyoxypropylene block copolymer; sorbitan fatty acid ester, polyoxyethylene sorbitan fatty acid ester, ethylene oxide/propylene oxide/ethylene oxide block polymer, propylene oxide/ethylene oxide/propylene oxide block polymer, and mixtures thereof.

8. The composition according to claim 7 wherein the non-ionic surfactant is a polyoxyethylene alkyl ether having the formula R—[O-(AO)ₙ]ₘ—H, where AO is an alkylene oxide unit selected from EO and PO, R is a hydrophobic group, n is at least about 5, m is from 1 to 3.

9. The composition according to claim 7 wherein the non-ionic surfactant is a ethylene oxide/propylene oxide/ethylene oxide block polymer having the formula HO(EO)ₐ(PO)_{b}(EO)ₐH where a is a number between about 1 to about 140 and b is a number between about 5 to about 100.

10. The composition according to claim 7 wherein the non-ionic surfactant is a propylene oxide/ethylene oxide/ propylene oxide block polymer having the formula HO(PO)_{b}(EO)ₐ(PO)_{b}H where a is a number between about 1 to about 140 and b is a number between about 5 to about 100.

11. An edge bead remover composition for a photoresist composition disposed as a film on a surface consisting essentially of:
from about 0.5 to about 8 Normal solution of a basic compound; and
from about 0.1 to about 10 wt % of a non-ionic surfactant.

12. The composition according to claim 11 wherein the basic compound is selected from the group consisting of ammonium hydroxides, organic amines, alkali metal compounds, alkaline earth metal compounds, and mixtures thereof.

13. The composition according to claim 11 wherein the basic compound is an ammonium hydroxide selected from the group consisting of tetramethylammonium hydroxide, tetraethylammonium hydroxide, tetrapropylammonium hydroxyl, tetrabutylammonium hydroxide, 2-hydroxy-trimethylammonium hydroxide, and mixtures thereof.

14. The composition according to claim 11 wherein the basic compound is an organic amine selected from the group consisting of monomethylamine, dimethylamine, trimethylamine, diethylamine, triethylamine, monoiso-pyruamine, di-isopyruamine, ethanolamine, and mixtures thereof.

15. The composition according to claim 11 wherein the basic compound is an alkali metal compound or a basic earth metal compound selected from the group consisting of lithium hydroxide, sodium hydroxide, potassium hydroxide, sodium hydrogen-phosphate, ammonium dihydrogen-phosphate, sodium dihydrogen-phosphate, potassium dihydrogen-phosphate, lithium phosphate, lithium silicate, potassium silicate, sodium silicate, lithium carbonate, potassium carbonate, sodium carbonate, lithium borate, sodium borate, and mixtures thereof.

16. The composition according to claim 11 wherein the non-ionic surfactant is selected from the group consisting of polyoxyethylene alkyl ether, polyoxyethylene/polyoxypropylene block copolymer; sorbitan fatty acid ester, polyoxyethylene sorbitan fatty acid ester, ethylene oxide/propylene oxide/ethylene oxide block polymer, propylene oxide/ethylene oxide/propylene oxide block polymer, and mixtures thereof.

17. The composition according to claim 16 wherein the non-ionic surfactant is a polyoxyethylene alkyl ether having the formula R—[O-(AO)ₙ]ₘ—H, where AO is an alkylene oxide unit selected from EO and PO, R is a hydrophobic group, n is at least about 5, m is from 1 to 3.

18. The composition according to claim 16 wherein the non-ionic surfactant is a ethylene oxide/propylene oxide/ethylene oxide block polymer having the formula HO(EO)ₐ(PO)_{b}(EO)ₐH where a is a number between about 1 to about 140 and b is a number between about 5 to about 100.

19. The composition according to claim 16 wherein the non-ionic surfactant is a propylene oxide/ethylene oxide/propylene oxide block polymer having the formula HO(PO)_{b}(EO)ₐ(PO)_{b}H where a is a number between about 1 to about 140 and b is a number between about 5 to about 100.

20. A process for removing photoresist edge bead and forming an image in the photoresist comprising the steps of:
a) forming a photoresist film on a substrate;
b) applying the edge bead remover composition of claim 1;
c) imagewise exposing the photoresist film;
d) developing the photoresist film; and
e) optionally heating the film before or after the developing step.

21. The process according to claim 20, wherein the edge bead remover composition further comprises from about 0.1 to about 10 wt % of a non-ionic surfactant.

22. The composition according to claim 21 wherein the non-ionic surfactant is selected from the group consisting of polyoxyethylene alkyl ether, polyoxyethylene/polyoxypropylene block copolymer; sorbitan fatty acid ester, polyoxyethylene sorbitan fatty acid ester, ethylene oxide/propylene oxide/ethylene oxide block polymer, propylene oxide/ethylene oxide/propylene oxide block polymer, and mixtures thereof.

23. The composition according to claim 22 wherein the non-ionic surfactant is a polyoxyethylene alkyl ether having the formula R—[O-(AO)ₙ]ₘ—H, where AO is an alkylene oxide unit selected from EO and PO, R is a hydrophobic group, n is at least about 5, m is from 1 to 3.

24. The composition according to claim 22 wherein the non-ionic surfactant is a ethylene oxide/propylene oxide/ethylene oxide block polymer having the formula HO(EO)ₐ(PO)_{b}(EO)ₐH where a is a number between about 1 to about 140 and b is a number between about 5 to about 100.

25. The composition according to claim 22 wherein the non-ionic surfactant is a propylene oxide/ethylene oxide/ propylene oxide block polymer having the formula HO(PO)_{b}(EO)ₐ(PO)_{b}H where a is a number between about 1 to about 140 and b is a number between about 5 to about 100.

26. A process for removing photoresist edge bead and forming an image in the photoresist comprising the steps of:
a) forming a photoresist film on a substrate;
b) applying the edge bead remover composition of claim 11;
c) imagewise exposing the photoresist film;
d) developing the photoresist film; and
e) optionally heating the film before or after the developing step.

27. The composition according to claim 26 wherein for b) the non-ionic surfactant is a polyoxyethylene alkyl ether having the formula R—[O-(AO)ₙ]ₘ—H, where AO is an alkylene oxide unit selected from EO and PO, R is a hydrophobic group, n is at least about 5, m is from 1 to 3.

28. The composition according to claim 26 wherein for b) the non-ionic surfactant is a ethylene oxide/propylene oxide/ethylene oxide block polymer having the formula HO(EO)ₐ(PO)_{b}(EO)ₐH where a is a number between about 1 to about 140 and b is a number between about 5 to about 100.

29. The composition according to claim 26 wherein for b) the non-ionic surfactant is a propylene oxide/ethylene oxide/propylene oxide block polymer having the formula HO(PO)_{b}(EO)ₐ(PO)_{b}H where a is a number between about 1 to about 140 and b is a number between about 5 to about 100.
